(19) United States
(12) Patent Application Publication
(10) Pub. No.: US 2018/0121386 A1
(43) Pub. Date: May 3, 2018

(54) SUPER SINGLE INSTRUCTION MULTIPLE DATA (SUPER-SIMD) FOR GRAPHICS PROCESSING UNIT (GPU) COMPUTING

(71) Applicant: Advanced Micro Devices, Inc., Sunnyvale, CA (US)

(72) Inventors: Jiasheng Chen, Orlando, FL (US); Angel E. Socarras, Orlando, FL (US); Michael Mantor, Orlando, FL (US); YunXiao Zou, Shanghai (CN); Bin He, Orlando, FL (US)

(73) Assignee: Advanced Micro Devices, Inc., Sunnyvale, CA (US)

(21) Appl. No.: 15/354,560

(22) Filed: Nov. 17, 2016

(30) Foreign Application Priority Data
Oct. 27, 2016 (CN) 201610953514.8

(51) Int. Cl. G06F 15/80; G06F 9/30; G06F 12/0875; G06F 12/0891

(52) U.S. Cl. CPC G06F 15/8007; G06F 9/3001; G06F 2212/604; G06F 12/0875; G06F 12/0891; G06F 9/30105

(57) ABSTRACT

A super single instruction, multiple data (SIMD) computing structure and a method of executing instructions in the super-SIMD is disclosed. The super-SIMD structure is capable of executing more than one instruction from a single or multiple thread and includes a plurality of vector general purpose registers (VGPRs), a first arithmetic logic unit (ALU), the first ALU coupled to the plurality of VGPRs, a second ALU, the second ALU coupled to the plurality of VGPRs, and a destination cache (Do$) that is coupled via bypass and forwarding logic to the first ALU, the second ALU and receiving an output of the first ALU and the second ALU. The Do$ holds multiple instructions results to extend an operand by-pass network to save read and write transactions power. A compute unit (CU) and a small CU including a plurality of super-SIMDs are also disclosed.

### CROSS REFERENCE TO RELATED APPLICATION

This application claims priority to Chinese Patent Application No. 201610953514.8, filed Oct. 27, 2016, the entire contents of which is hereby incorporated by reference as if fully set forth herein.

### BACKGROUND

Present graphics processing units (GPU) of different scales have a wide range of applications, ranging from use in tablet computers to supercomputer clusters. However, improvements to GPU architectures (as well as CPU types of architectures) typically involve the potentially conflicting challenges to increase performance per silicon area unit and performance per watt. The application profiling statistical data shows that although most instructions in GPU compute units are multiply/add (MAD) and multiplication operations (MUL), the hardware implementation of those essential operations take less than half of the arithmetic logic units (ALU) silicon area footprint.

For vector general purpose register (VGPR) files implementations, GPU compute units with Single Instruction Multiple Data (SIMD) architecture can use multiple memory blocks. Generally, a SIMD architecture represents a parallel computing system having multiple processing elements that perform the same operation on multiple data points simultaneously. SIMD processors are able to exploit data level parallelism, by performing simultaneous (parallel) computations on a single process (instruction) at a given moment. The SIMD architecture is particularly applicable to common tasks like adjusting the contrast in a digital image or adjusting the volume of digital audio.

The memory blocks used in SIMD processors can include static random access memory blocks (SRAMs) which may take more than 30% of the power and area of the SIMD compute unit. For example, in certain configurations the GPU compute unit can issue one SIMD instruction every four cycles. VGPR file can provide 4Read-4Write (4R4 W) in four cycles, but profiling data also shows that VGPR bandwidth is not fully utilized as the average number of reads per instruction is about two. Since an ALU pipeline can be multiple cycles deep and have a latency of few instructions, a need exists to more fully utilize VGPR bandwidth.

### BRIEF DESCRIPTION OF THE DRAWINGS

A more detailed understanding can be had from the following description, given by way of example in conjunction with the accompanying drawings wherein:

FIG. 1A illustrates an exemplary SIMD structure;

FIG. 1B illustrates an exemplary super-SIMD structure;

FIG. 2 illustrates a super-SIMD block internal architecture;

FIG. 3 illustrates an exemplary compute unit with four super-SIMD blocks, two texture units, one instruction scheduler, and one local data storage;

FIG. 4 illustrates an exemplary compute unit with two super-SIMD blocks, a texture unit, a scheduler, and a local data storage (LDS) buffer connected with an L1 cache; and

FIG. 5 illustrates a method of executing instructions in the compute units of FIGS. 1-4; and

FIG. 6 is a block diagram of an example device in which one or more disclosed embodiments can be implemented.

### DETAILED DESCRIPTION

A super single instruction, multiple data (SIMD) computing structure is disclosed. The super-SIMD structure is capable of executing more than one instruction from a single or multiple thread and includes a plurality of vector general purpose registers (VGPRs), a first arithmetic logic unit (ALU), the first ALU coupled to the plurality of VGPRs, a second ALU, the second ALU coupled to the plurality of VGPRs, and a destination cache (Do$) that is coupled via bypass and forwarding logic to the first ALU and the second ALU and receiving an output of the first ALU and the second ALU. The first ALU can be a full ALU. The second ALU can be a core ALU. The Do$ holds multiple instructions to extend an operand by-pass network to save read and write transactions' power.

A compute unit (CU) is also disclosed. The CU includes a plurality of super single instruction, multiple data execution units (SIMDs), each super-SIMD including: a plurality of vector general purpose registers (VGPRs) grouped in sets, a plurality of first arithmetic logic units (ALUs), each first ALU coupled to one set of the plurality of VGPRs, a plurality of second ALUs, each second ALU coupled to one set of the plurality of VGPRs, and a plurality of destination caches (Do$s), each Do$ coupled to one first ALU and one second ALU and receiving an output of the one first ALU and one second ALU. The CU includes a plurality of texture address/texture data units (TATDs) coupled to at least one of the plurality of super-SIMDs, an instruction scheduler (SQ) coupled to each of the plurality of super-SIMDs and the plurality of TATDs, a local data storage (LDS) coupled to each of the plurality of super-SIMDs, the plurality of TATDs, and the SQ, and a plurality of L1 caches, each of the plurality uniquely coupled to one of the plurality of TATDs.

A small compute unit (CU) is also disclosed. The small CU includes two super single instruction, multiple data (SIMDs), each super-SIMD including: a plurality of vector general purpose registers (VGPRs) grouped into sets of VGPRs, a plurality of first arithmetic logic units (ALUs), each first ALU coupled to one set of the plurality of VGPRs, a plurality of second ALUs, each second ALU coupled to one set of the plurality of VGPRs, and a plurality of destination caches (Do$s), each Do$ coupled to one first ALU of the plurality of first ALUs and one second ALU of the plurality of second ALUs and receiving an output of the one first ALU and one second ALU. The small CU includes a texture unit (TATD) coupled to the super-SIMDs, an instruction scheduler (SQ) coupled to each of the super-SIMDs and the TATD, a local data storage (LDS) coupled the super-SIMDs, the TATD, and the SQ, and an L1 cache coupled to the TATD.

A method of executing instructions in a super single instruction, multiple data execution unit (SIMD) is disclosed. The method includes generating instructions using instruction level parallel optimization, allocating wave slots for the super-SIMD with a PC for each wave, selecting a VLIW2 instruction from a highest priority wave, reading a plurality of vector operands in the super-SIMD, checking a plurality of destination operand caches (Do$s) and mark the operands able to be fetched from Do$, scheduling a register file and read the Do$ to execute the VLIW2 instruction, and updating the PC for the selected waves. The method can include allocating a cache line for each instruction result and stalling and flashing cache if the allocating needs more cache lines. The method can also include repeating the selecting, the reading, the checking and the marking, the scheduling and the reading to execute, and updating until all waves are completed.

VLIW2 includes two regular instructions in a larger instruction word. A wave is a wavefront that includes a collection of 64 or a proper number of work-items grouped for efficient processing on the compute unit with each wavefront sharing a single program counter.

By way of introduction, modern CPU designs are super scalar and enable issuing multiple instructions per cycle. These designs have complex out of order and register renaming that is unnecessary for GPUs. For example, CPU SIMDs are typically 4 or 8 operations per cycle, while GPUs can be 16, 32 or 64 operations per cycle. Some GPU designs can have a plurality of register caches to cache the source operands from a multiple bank register file and include a compiler to perform register allocation. Register allocation can avoid bank conflict and improve the register caching performance.

In situations where a by-pass/forwarding network is added with instant destination buffer or cache, VGPR reads can be saved. This opens the opportunity to simultaneously provide input data for more than one instruction. In certain current GPU architectures, the instructions per cycle (IPC) rate is only 0.25 instructions per cycle and improvement provides for better overall performance. Improvements in these factors provide an opportunity to increase the IPC rate by issuing multiple SIMD instructions together. Such an approach can be defined as “super-SIMD architecture.” Such a super-SIMD architecture can have significant advantage on power/performance compared to existing SIMD compute units in GPUs.

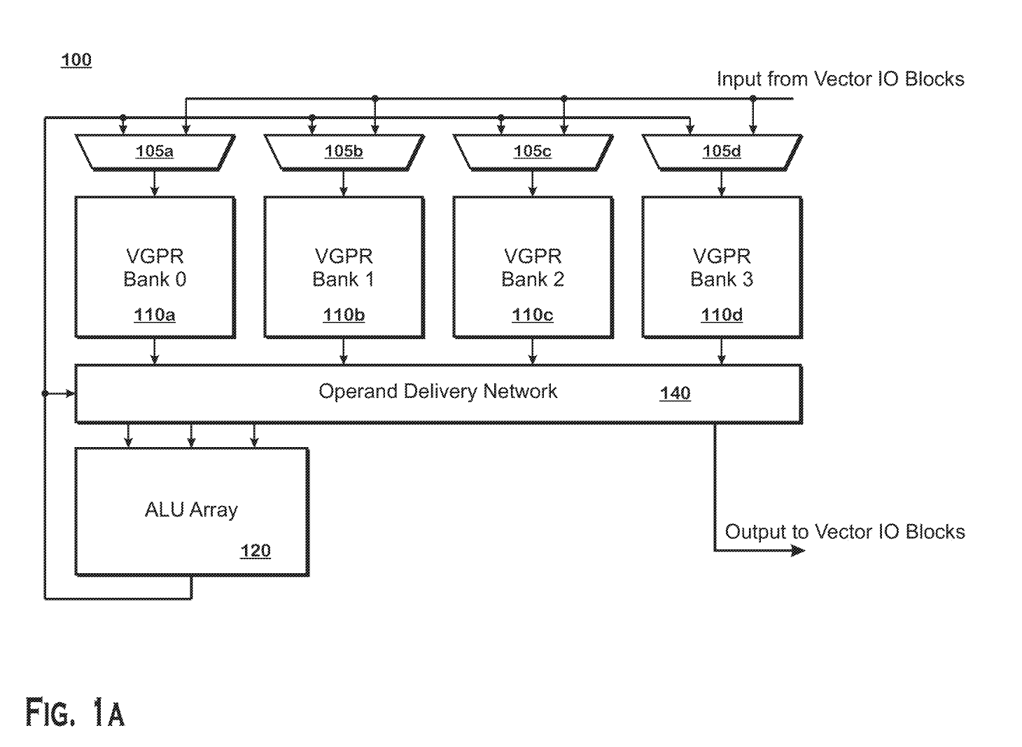

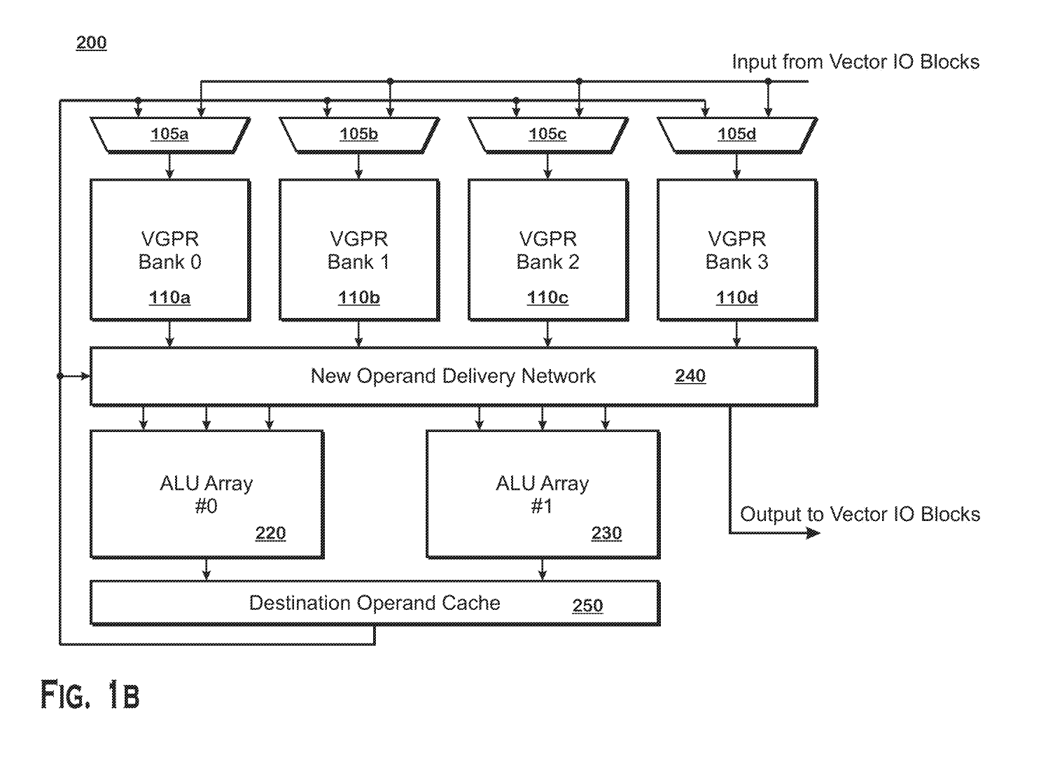

FIG. 1A illustrates an exemplary SIMD block 100. SIMD block 100 is a device that provides parallel execution units that follow the order by a single instruction. SIMD block 100 includes a multi-bank VGPR 110, N number of parallel ALUs 120, where N is equal to the width of the SIMD (a width of one is shown in FIG. 1A). For example, in a machine that is SIMD16, 16 ALUs 120 are used. A number of multiplexors 105 can be used to feed the multi-bank VGPR 110.

SIMD block 100 includes a plurality of VGPRs 110. VGPRs 110 operate as quickly accessible locations available to a digital processing unit (PU) (not shown). Data from a larger memory is loaded into the plurality of VGPRs 110 to be used for arithmetic operations and manipulated or tested by machine instructions. In an implementation, a plurality of VGPRs 110 includes VGPRs that hold data for vector processing done by SIMD instructions. SIMD block 100 is represented showing four VGPRs 110a,b,c,d although as would be understood by those possessing an ordinary skill in the art that any number of VGPRs can be utilized. Associated with the four VGPRs 110a,b,c,d are four multiplexors 105a,b,c,d that are used to feed the VGPRs 110a,b,c,d. Multiplexors 105a,b,c,d receive input from ALUs 120 and from Vector IO blocks (not shown).

For example, SIMD block 100 executes a vector of ALU (VALU) operations by reading one or multiple (e.g., 1-3) VGPRs 110 as source operands and write a VGPR as the destination result, where the vector size is the SIMD width.

The outputs of VGPRs 110a,b,c,d are provided to an operand delivery network 140. In an implementation, the operand delivery network 140 includes a crossbar and other delivery mechanisms including, at least, a decoder of opcode instructions.

Operand delivery network 140 propagates the signals to an arithmetic logic unit (ALU) 120. In an implementation, ALU 120 is a full ALU. ALU 220 is a combinational digital electronic circuit that performs arithmetic and bitwise operations on integer binary and floating point numbers. In an implementation, individual ALUs are combined to form VALU. The inputs to ALU 120 are the data to be operated on, called operands, a code indicating the operation to be performed, and, optionally, status information from a previous operation. The output of ALU 120 is the result of the performed operation.

FIG. 1B illustrates an exemplary super-SIMD block 200. Super-SIMD 200 is an optimized SIMD for better performance per mm² and watt. Super-SIMD block 200 includes a plurality of VGPRs 110 described above with respect to FIG. 1A. Super-SIMD block 200 is represented showing four VGPRs 110a,b,c,d although, as would be understood by those possessing an ordinary skill in the art, any number of VGPRs can be utilized. Associated with the four VGPRs 110a,b,c,d can be four mutliplexors 105a,b,c,d used to feed the VGPRs 110a,b,c,d. Multiplexors 105a,b,c,d can receive input from a destination operand cache (Do$) 250 and from Vector IO blocks (not shown).

The outputs of VGPRs 110a,b,c,d are provided to an operand delivery network 240. In an implementation, operand delivery network 240 includes a crossbar and other delivery mechanisms at least including a decoder of opcode instructions. Operand delivery network 240 operates to provide additional signals beyond that provided by operand delivery network 140 of FIG. 1A.

Operand delivery network 240 propagates the signals to a pair of ALUs configured in parallel. The pair of ALUs includes a first ALU 220 and a second ALU 230. In an implementation, first ALU 220 is a full ALU and second ALU 230 is a core ALU. In another implementation, first ALU 220 and second ALU 230 represent the same type of ALU that includes either full ALUs or core ALUs. The additional ALU (having two ALUs in FIG. 1B as opposed to one ALU in FIG. 1A) in super-SIMD 200 provides the capability to execute certain opcodes, and enable super-SIMD 200 to co-issue two vector ALU instructions (perform in parallel) from the same or different wave. A “certain opcode” is an opcode that is executed by a core ALU, and may be referred to as a “mostly used opcode” or “essential opcode.” For an understanding, and as will be further described below, side ALUs do not have multipliers although side ALUs aid in implementing non-essential operations like conversion instructions. As will be further described below, a full ALU is a combination of a core ALU and a side ALU working together to perform operations including complex operations. A wave is a wavefront that includes a collection of 64, or a proper number of work-items based on the dimension of the SIMD, grouped for efficient processing on the compute unit with each wavefront sharing a single program counter.

Super-SIMD 200 is based on the premise that GPUs SIMD unit have multiple execution ALU units 220 and 230 and instruction schedulers able to issue multiple ALU instructions from the same wave or different waves to fully utilize the ALU compute resources.

Super-SIMD 200 includes Do$ 250 which holds up to eight or more ALU results to provide super-SIMD 200 additional source operands or bypass the plurality of VGPRs 110 for power saving. The results of ALU 220,230 propagate to Do$ 250. Do$ 250 is interconnected to the input of ALUs 220, 230 via operand delivery network 240. Do$ 250 provides additional operand read ports. Do$ 250 holds multiple instructions, such as 8 or 16 previous VALU instruction results, to extend the operand's by-pass network to save read and write power and increase the VGPR file read bandwidth

Software and hardware co-work to issue instructions referred to as co-issuing. The compiler (not shown) performs instruction level parallel scheduling and generates VLIW instructions for executing via super-SIMD 200. In an implementation, super-SIMD 200 is provided instructions from a hardware instruction sequencer (not shown) in order to issue two VALU instructions from different waves when one wave cannot feed the ALU pipeline.

If super-SIMD 200 is an N wide SIMD, implementations have N number of full ALUs allowing for N mul_add operations and other operations including transcendental operations, non-essential operations like move and conversion. Using the SIMD block 100 shown in FIG. 1A, one VALU operation can be executed per cycle. Using super-SIMD block 200 of FIG. 1B with multiple types of ALUs in one super-SIMD, each set can have N ALUs where N is the SIMD width. In certain implementations, ½, ¼, or ⅛ of N ALUs use transcendental ALUs (T-ALUs) with multiple cycle execution to save area and cost.

Several common implementations of super-SIMD blocks 200 can be utilized. These include the first ALU 220 and second ALU 230 both being a full ALU, first ALU 220 being a full ALU and second ALU 230 being a core ALU or vice versa, and coupling multiple super-SIMD blocks 200 in an alternating fashion across the super-SIMD blocks 200 utilizing one pair of core ALUs in a first block for first ALU 220 and second ALU 230, one set of side ALUs in a next block for first ALU 220 and second ALU 230, and one set of T-ALUs in a last block for first ALU 220 and second ALU 230.

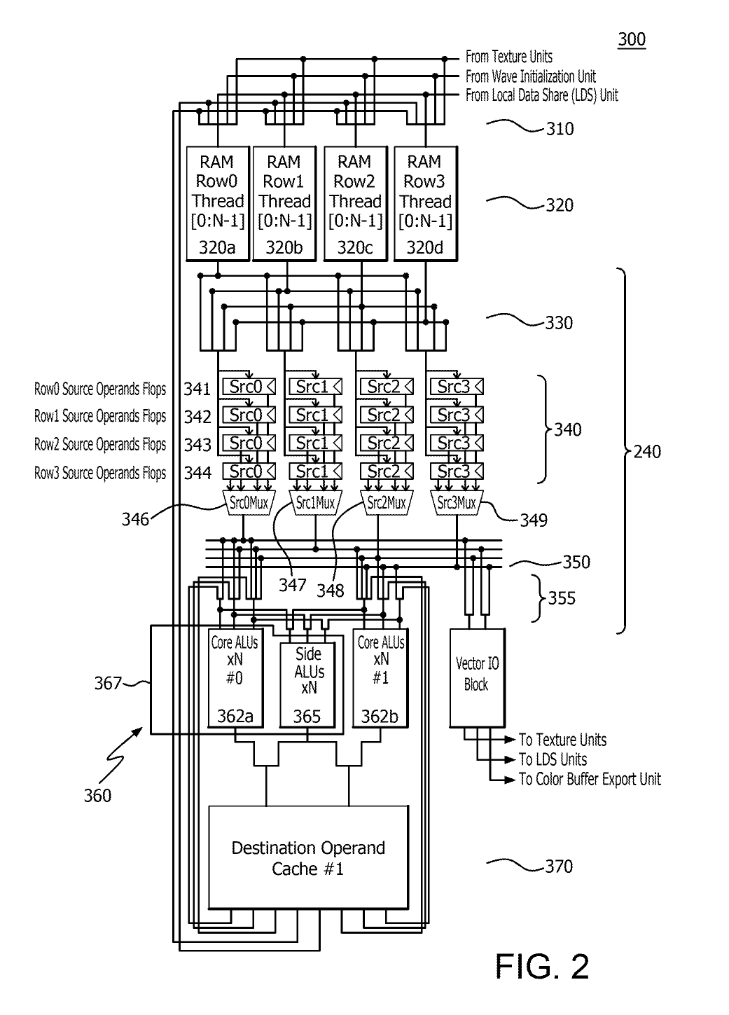

By way of further example, and to provide additional details, one implementation of super-SIMD block 200 where first ALU 220 is a full ALU and second ALU 230 is a core ALU is illustrated in FIG. 2. FIG. 2 illustrates a super-SIMD block architecture 300. Super-SIMD block 300 includes a VGPR data write selector 310 that receives data from at least one of texture units (not shown in FIG. 2), wave initialization units (not shown in FIG. 2), and local data share (LDS) unit (not shown in FIG. 2). Selector 310 provides data input into RAMs 320 (shown as 110 in FIG. 1B) that in turn output to read crossbar 330 which outputs to the set of source operands flops 340. Flops 340 output to crossbar 350 with the data then progressing to execution units 360 and to destination cache units (Do$) 370. Crossbar 350 outputs to a vector input/output block and then to texture units (not shown in FIG. 2), LDS units (not shown in FIG. 2), and color buffer export unit (not shown in FIG. 2). Do$ 370 is consistent with Do$ 240 of FIG. 1B. Crossbar 330, source operand flops 340, multiplexors 346, 347, 348, 349, and crossbar 350 are components in the operand delivery network 240 (shown in FIG. 1B).

Super-SIMD block 300 includes VGPR storage RAMs 320. RAMs 320 can be configured as a group of RAMs including four bank RAMs 320a, 320b, 320c, 320d. Each bank RAM 320 can include M×N×W bits data, where M is the number of word lines of RAM, N is the number of threads of SIMD, w is the ALU bit width, a VGPR holds N×W bits of data, the four bank of VGPRs holds 4×M number of VGPRs, and a typical configuration can be 64×4×32 bits, which can hold 4 threads VGPR context up to 64 number of entries with 32 bits for each thread, VGPR contains 4×32 bits of data in this implementation.

Super-SIMD block 300 includes vector execution units 360. Each vector execution unit 360 includes two sets of core ALUs 362a, 362b and one set of side ALUs 365, each having N number of ALUs equal to the SIMD width. Core ALU 362a can be coupled with side ALU 365 to form a full ALU 367. Full ALU 367 is the second ALU 230 of FIG. 1B. Core ALU 362b is the first ALU 220 of FIG. 1B.

In an implementation, core ALUs 362a, 362b have N× multipliers to aid in implementing all the certain single precision floating point operations like fused multiply-add (FMA). In an implementation, side ALUs 365 do not have multipliers but could help to implement all the non-essential operations like conversion instructions. Side ALUs 365 could co-work with any one core ALUs 362a, 362b to finish complex operations like transcendental instructions.

Do$ 370 is deployed to provide enough register read ports to provide two SIMD4 (4 wide SIMD) instructions every cycle at max speed.

For example, in single instruction data flow, bank of RAMs 320 provide the register files with each register file holding N threads of data. In total, there are N*R threads in VGPR context, where R is the number of rows and could be from 1 to many, often referred to as Row0 thread[0:N−1], Row1 thread[0:N−1], Row2 thread[0:N−1] and Row3 thread[0:N−1] to RowR[0:N−1].

An incoming instruction is set forth as:

V0=V1*V2+V3 (a MAD_F32 instruction.)

Super-SIMD block 300 requests to do N*Rr threads of MUL_ADD, super-SIMD block 300 performs the following:

Cycle 0: Row0's V0=Row0's V1*Row0's V2+Row0's V3

Cycle 1: Row1's V0=Row1's V1*Row1's V2+Row1's V3

Cycle 2: Row2's V0=Row2's V1*Row2's V2+Row2's V3

Cycle 3: Row3's V0=Row3's V1*Row3's V2+Row3's V3

Cycle R: RowR's V0=RowR's V1*RowR's V2+RowR's V3.

Super-SIMD block 300 includes a VGPR read crossbar 330 to read all of the 12 operands in 4 cycles and write to the set of source operands flops 340. In an implementation, each operand is 32 bits by 4. Source operand flops 340 include a row0 source operand flops 341, a row1 source operand flops 342, a row2 source operand flops 343, and a row3 source operand flops 144. In an implementation, each row (row0, row1, row2, row3) includes a first flop Src0, a second flop Src1, a third flop Src2, and a fourth flop Src3.

The Vector Execution Unit 360 source operands input crossbar 355 delivers the required operands from the source operand flops 340 to core ALUs 362a, 362b, cycle 0 it would execute Row0's N threads inputs, cycle 1 for Row1, then Row2 and Row3 through RowR.

After an ALU pipeline delay, a write to the destination operand caches (Do$) 370 is performed. In an implementation, the delay is 4 cycles. In an implementation, the write includes 128 bits every cycle for 4 cycles.

The next instruction can be issued R cycles after the first operation. If the next instruction is V4=MIN_F32 (V0, V5), for example, the instruction scheduler checks the tag of the Do$ 370 and the instruction scheduler can get a hit on the Do$ 370 if the instruction was an output of previous instruction. In such a situation, the instruction scheduler schedules a read from the Do$ 370 instead of scheduling a VGPR read from the RAMs 320. In an implementation, MIN_F32 is not an certain opcode, then it would be executed at the side ALUs 365 which share the inputs from the core ALUs 362a, 362b. If the next instruction is a transcendental operation like RCP_F32, in an implementation, it can be executed at side ALUs 365 as V6=RCP_F32(V7). If V7 is not in the Do$ 370, V7 is delivered from the Src0 Flops 340 and routed to core ALUs 362a, 362b and the side ALUs 365.

Super-SIMD block 300 supports two co-issued vector ALU instructions in every instruction issue period or one vector ALU and one vector IO instruction. However, register read port conflicts and conflicts with the functional unit limit the co-issue opportunity (i.e., two co-issued vector ALU instructions in every instruction issue period or one vector ALU and one vector IO instruction in the period). A read port conflict occurs when two instructions simultaneously are being read from the same memory block. A functional unit conflict occurs when two instructions of the same type are attempting to use a single functional unit (e.g., MUL).

A functional unit conflict limits the issuance of two vector instructions if: (1) both instructions are performing certain opcodes executed by core ALU 362a, 362b, or (2) one instruction is performing an certain opcode executed by core ALU 362a, 362b and the other instruction uses the side ALU 365. An certain opcode is an opcode that is executed by a core ALU 362a, 362b. Some operations need two core ALUs 362a, 362b allowing for issuing one vector instruction at one time. One of core ALU (shown as 362a) can be combined with side ALU 365 to operate as full ALU 367 shown in FIG. 1B. Generally, a side ALU and core ALU have different functions and an instruction can be executed in either the side ALU or the core ALU. There are some instructions that can use the side ALU and core ALU working together—the side ALU and core ALU working together is a full ALU.

The storage RAM 320 and read crossbar 330 provide four operands (N*Wbits) every cycle, the vector source operands crossbar 350 delivers up to 6 operands combined with the operands read from Do$ 370 to support two vector operations with 3 operands each.

A compute unit can have 3 different vector ALU instructions, three operands like MAD_F32, two operands like ADD_F32 and one operand like MOV_B32. The number after an instructions name MUL#, ADD#, and MOV# is the size of the operand in bits. The number of bits can include 16, 32, 64 and the like. MAD performs d=a*b+c and requires 3 source operands per operation. ADD performs a+b and requires 2 source operands per operation. MOC performs d=c and requires 1 operand per operation.

For a vector ALU instruction executed at core ALU 362a, source A comes from Src0Mux 346 output or Do$ 370, source B, if this is a 3 operands or 2 operand instruction, comes from Src0Mux 346 output, Src1Mux 347 output or Do$ 370, and source C, if this is a 3 operand instruction, comes from Src0Mux 346 output, Src1Mux 347 output, Src2Mux 348 output or Do$ 370.

For a vector ALU instruction executed at core ALU 362b, source A comes from Src1Mux 347 output, Src2Mux 348 output, Src3Mux 349 output or Do$ 370, source B, if this is a 3 operand or 2 operand instruction, comes from Src2Mux 348 output, Src3Mux 349 output or Do$ 370, and source C, if this is a 3 operand instruction, comes from Src3Mux 349 output or Do$ 370.

If a vector IO (texture fetch, lds (local data share) operation or pixel color and vertex parameter export operations) instruction is issued having a higher vector register file access priority, the vector IO can need the operands output result from src2Mux 348, src3Mux 349 or src0Mux 346 and src1Mux 347 thereby blocking vector ALU instructions that conflict with those VGPR deliver paths.

As described above, FIG. 2 shows one implementation of super-SIMD block 200 where first ALU 220 is a full ALU and second ALU 230 is a core ALU. However, a number of multiplexors (MUXes) have been removed from FIG. 2 for clarity in order to clearly show the operation and implementation of the super-SIMD. The MUXes can be included in the design to accumulate signals that are input and select one or more of the input signals to forward along as an output signal.

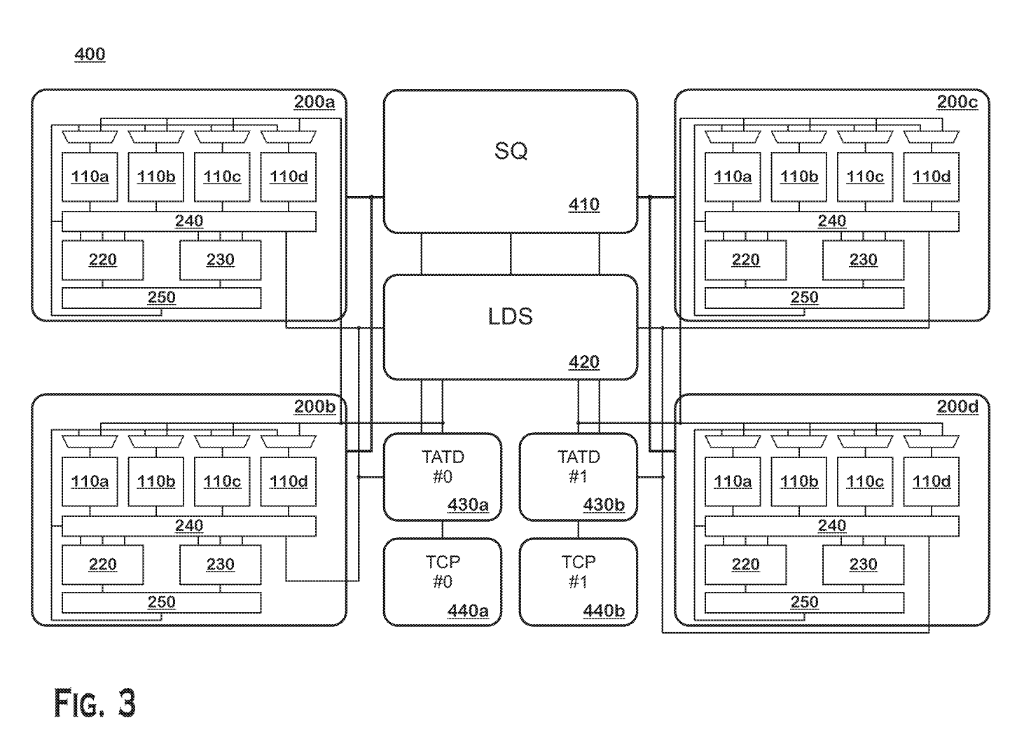

A super-SIMD based compute unit 400 with four super-SIMDs 200a,b,c,d, two TATDs 430a,b, one instruction scheduler 410, and one LDS 220 is illustrated in FIG. 3. Each super-SIMD is depicted as super-SIMD 300 described in FIG. 1B and can be of the configuration shown in the example of FIG. 2. For completeness, super-SIMD 200a includes ALU units 220 and 230 and VGPRs 110a,b,c,d. Super-SIMD 200a can have a Dogs 250 to provide additional operand read ports. Do$ 250 holds multiple (typical value might be 8 or 16 instructions per cycle) instructions' destination data to extend the operand's by-pass network to save the main VGPR 110 read and write power. Super-SIMD 200a is an optimized SP (SIMD pair) for better performance per mm² and watt. Super-SIMDs 200b,c,d can be constructed similar to super-SIMD 200a. This construction can include the same ALU configuration, or alternatively in certain implementations, can include other types of ALU configurations discussed as being selectable herein.

In conjunction with super-SIMD 200a,b,c,d, super-SIMD based compute unit 400 can include an SQ 410, an ILDS 420, two texture units 430a,b interconnected with two L1 caches 440a,b, also referred to as TCP. LDS 420 can utilize a 32 bank of 64k or 128k or proper size based on target application. L1 cache 440 can be a 16k or proper size cache.

Super-SIMD based compute unit 400 can provide the same ALU to texture ratio found in a typical compute unit while allowing for better L1 performance 440. Super-SIMD based compute unit 400 can provide a similar level of performance with potentially less area savings as compared to SIMDs (shown as 100 in FIG. 1A) two compute units. Super-SIMD based compute unit 400 can also include 128k LDS with relative small area overhead for improved VGPR spilling and filling to enable more waves.

Do$ 250 stores the most recent ALU results which might be re-used as source operands of the next instruction. Depending on the performance and cost requirements, Do$ 250 can hold 8 to 16 or more ALU destinations. Waves can share the same Do$ 250. SQ 410 can be expected to keep issue instructions from the oldest wave. Each entry of the Do$ 250 can have tags with fields. The fields can include: (1) valid bit and write enable signals for each lane; (2) VGPR destination address; (3) the result had written to main VGPR; (4) age counter; and (5) reference counter. When the SQ 410 schedules a VALU instruction, an entry from the operand cache can be allocated to hold the ALU destination. This entry could be: (1) a slot that does not hold valid data; (2) a slot that has valid data and has been written to main VGPR; and (3) a valid slot that has the same VGPR destination. The age counter can provide information about the age of the entry. The reference counter can provide information about the number of times this value was used as a source operand.

The VALU destination does not need to be written to main VGPR every cycle, as Do$ 250 can provide the ability to skip the write for write and write cases, such as those intermediary results for accumulated MUL-ADD. An entry can write back to main VGPR when all entry hold data is valid and un-written back data exists and this entry is the oldest and least referenced data. When SQ 410 is unable to find an entry to hold next issued instruction result, it can issue a flush operation to flush certain entry or all entry back to main VGPR. Synchronization between non-ALU operation Do$ 250 can be able to feed the source for LDS 420 store, texture store and color and attribute export. Non-ALU writes can write to main VGPR directly, any entry of Do$ 250 matched with the destination can be invalidated.

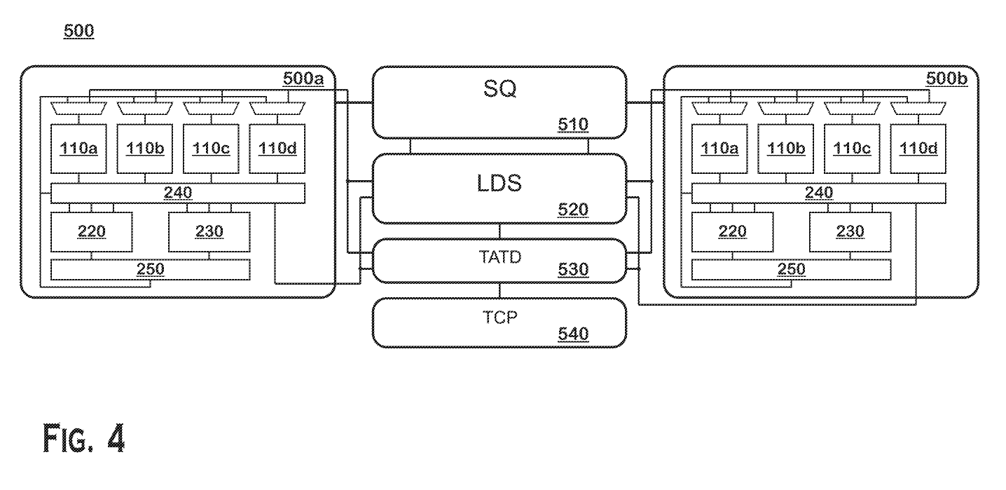

FIG. 4 illustrates a small compute unit 500 with two super-SIMDs 500a,b, a texture unit 530, a scheduler 510, and an LDS 520 connected with an L1 cache 540. The component parts of each super-SIMD 500a,b, can be as described above with respect to super-SIMDs of FIG. 1B and the specific example shown in FIG. 2 and super-SIMD of FIG. 3. In small compute unit 500, two super-SIMDs 500a,b replace the four single issue SIMDs. In CU 500, the ALU to texture ratio can be consistent with known compute units. Instruction per cycle (IPC) per wave can be improved and a reduced wave can be required for 32 KB VGPRs. CU 500 can also realize lower cost versions of SQ 510 and LDS 520.

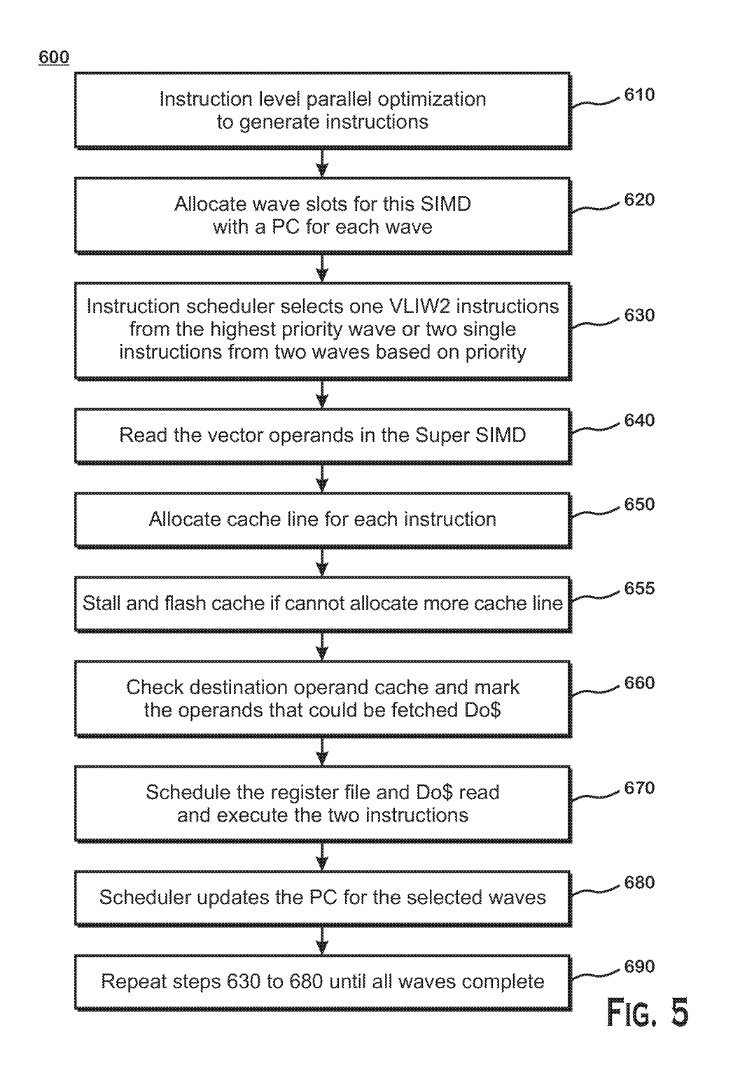

FIG. 5 illustrates a method 600 of executing instructions such as in the example devices of FIGS. 1B-4. Method 600 includes instruction level parallel optimization to generate instructions at step 610. At step 620, the wave slots for the SIMD are allocated with a program counter (PC) for each wave. At step 630, the instruction scheduler selects one VLIW2 instruction from the highest priority wave or two single instructions from two waves based on priority. The vector operands of the selected instruction(s) are read in the super-SIMD at step 640. At step 650, the compiler allocates cache lines for each instruction. A stall optionally occurs if the device cannot allocate the necessary cache lines at step 655, and during the stall additional cache is flashed. At step 660, the destination operand cache is checked and the operands that can be fetched from Do$ are marked. At step 670, the register file is scheduled, the Do$ read and the instruction(s) executed. At step 680, the scheduler updates the PC for the selected waves. Step 690 provides a loop of step 630 to step 680 until all waves are complete.

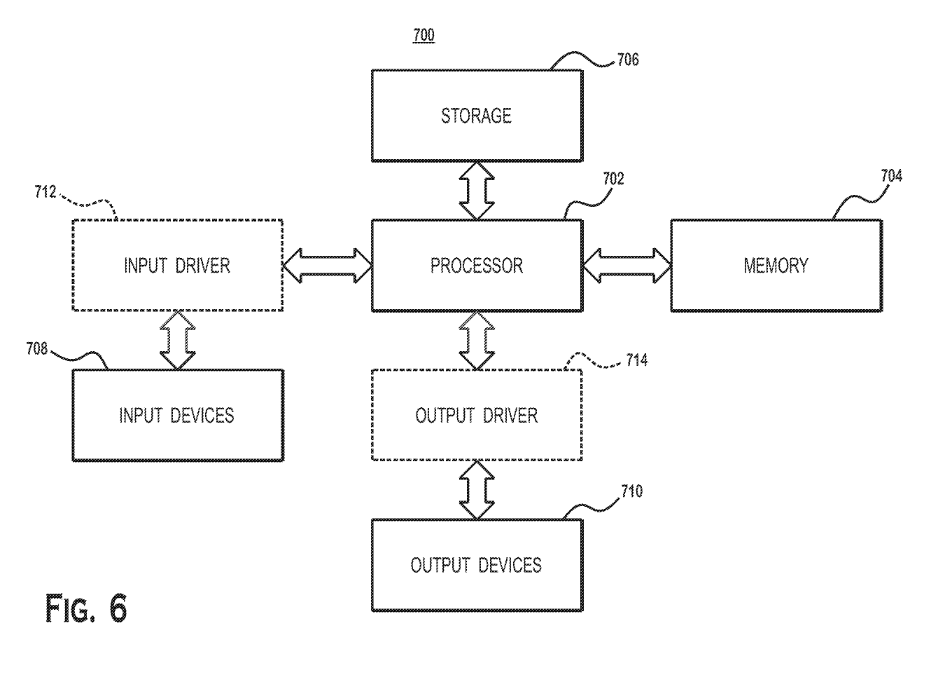

FIG. 6 is a block diagram of an example device 700 in which one or more disclosed embodiments can be implemented. The device 700 can include, for example, a computer, a gaming device, a handheld device, a set-top box, a television, a mobile phone, or a tablet computer. The device 700 includes a processor 702, a memory 704, a storage 706, one or more input devices 708, and one or more output devices 710. The device 700 can also optionally include an input driver 712 and an output driver 714. It is understood that the device 700 can include additional components not shown in FIG. 6.

The processor 702 can include a central processing unit (CPU), a graphics processing unit (GPU), a CPU and GPU located on the same die, or one or more processor cores, wherein each processor core can be a CPU or a GPU. The memory 704 can be located on the same die as the processor 702, or can be located separately from the processor 702. The memory 704 can include a volatile or non-volatile memory, for example, random access memory (RAM), dynamic RAM, or a cache.

The storage 706 can include a fixed or removable storage, for example, a hard disk drive, a solid state drive, an optical disk, or a flash drive. The input devices 708 can include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 710 can include a display, a speaker, a printer, a haptic feedback device, one or more lights, an antenna, or a network connection (e.g., a wireless local area network card for transmission and/or reception of wireless IEEE 802 signals).

The input driver 712 communicates with the processor 702 and the input devices 708, and permits the processor 702 to receive input from the input devices 708. The output driver 714 communicates with the processor 702 and the output devices 710, and permits the processor 702 to send output to the output devices 710. It is noted that the input driver 712 and the output driver 714 are optional components, and that the device 700 will operate in the same manner if the input driver 712 and the output driver 714 are not present.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements functions disclosed herein.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A super single instruction, multiple data (SIMD), the super-SIMD structure capable of executing more than one instruction from a single or multiple thread comprising:
a plurality of vector general purpose registers (VGPRs);
a first arithmetic logic unit (ALU), the first ALU coupled to the plurality of VGPRs;
a second ALU, the second ALU coupled to the plurality of VGPRs; and
a destination cache (Do$s) that is coupled via bypass and forwarding logic to the first ALU and the second ALU and receiving an output of the first ALU and the second ALU.

2. The super-SIMD of claim 1 wherein the first ALU is a full ALU.

3. The super-SIMD of claim 1 wherein the second ALU is a core ALU.

4. The super-SIMD of claim 3 wherein the core ALU is capable of executing certain opcodes.

5. The super-SIMD of claim 1 wherein the Do$ holds multiple instructions results to extend an operand by-pass network to save read and write transactions power.

6. A compute unit (CU), the CU comprising:
a plurality of super single instruction, multiple data execution units (SIMDs), each super-SIMD including:
a plurality of vector general purpose registers (VGPRs) grouped in sets;
a plurality of first arithmetic logic units (ALUs), each first ALU coupled to one set of the plurality of VGPRs;
a plurality of second ALUs, each second ALU coupled to one set of the plurality of VGPRs; and
a plurality of destination caches (Do$s), each Do$ coupled to one first ALU and one second ALU and receiving an output of the one first ALU and one second ALU;
a plurality of texture units (TATDs) coupled to at least one of the plurality of super-SIMDs;
an instruction scheduler (SQ) coupled to each of the plurality of super-SIMDs and the plurality of TATDs;
a local data storage (LDS) coupled to each of the plurality of super-SIMDs, the plurality of TATDs, and the SQ; and
a plurality of L1 caches, each of the plurality uniquely coupled to one of the plurality of TATDs.

7. The CU of claim 6 wherein the plurality of first ALUs includes four ALUs.

8. The CU of claim 6 wherein the plurality of second ALUs include sixteen ALUs.

9. The CU of claim 6 wherein the plurality of Do$s hold sixteen ALU results.

10. The CU of claim 6 wherein the plurality of Do$s hold multiple instructions results to extend an operand by-pass network to save read and write transactions power.

11. A small compute unit (CU), the CU comprising:
two super single instruction, multiple data (SIMDs), each super-SIMD including:
a plurality of vector general purpose registers (VGPRs) grouped into sets of VGPRs;
a plurality of first arithmetic logic units (ALUs), each first ALU coupled to one set of the plurality of VGPRs;
a plurality of second ALUs, each second ALU coupled to one set of the plurality of VGPRs; and
a plurality of destination caches (Do$s), each Do$ coupled to one first ALU of the plurality of first ALUs and one second ALU of the plurality of second ALUs and receiving an output of the one first ALU and one second ALU;
a texture address/texture data units (TATD) coupled to the super-SIMDs;
an instruction scheduler (SQ) coupled to each of the super-SIMDs and the TATD;
a local data storage (LDS) coupled the super-SIMDs, the TATD, and the SQ; and
an L1 cache coupled to the TATD.

12. The small CU of claim 11 wherein the plurality of first ALUs comprise full ALUs.

13. The small CU of claim 11 wherein the plurality of second ALUs comprise core ALUs.

14. The small CU of claim 13 wherein the core ALUs are capable of executing certain opcodes.

15. The small CU of claim 11 wherein the plurality of Do$s hold sixteen ALU results.

16. The small CU of claim 11 wherein the plurality of Do$s hold multiple instructions to extend an operand by-pass network to save read and write power.

17. A method executing instructions in a super single instruction, multiple data execution unit (SIMD), the method comprising:
generating instructions using instruction level parallel optimization;
allocating wave slots for the super-SIMD with a PC for each wave;
selecting a VLIW2 instruction from a highest priority wave;
reading a plurality of vector operands in the super-SIMD;
checking a plurality of destination operand caches (Do$s) and mark the operands able to be fetched from Do$;
scheduling a register file and read the Do$ to execute the VLIW2 instruction; and
updating the PC for the selected waves.

18. The method of claim 17 further comprising allocating a cache line for each instruction result.

19. The method of claim 18 further comprising stalling and flashing cache if the allocating needs more cache lines.

20. The method of claim 17 wherein the selecting, the reading, the checking and the marking, the scheduling and the reading to execute, and updating are repeated until all waves are completed.
